(19) United States
(12) Patent Application Publication
(10) Pub. No.: US 2013/0180872 A1
(43) Pub. Date: Jul. 18, 2013

(54) SELF-CLEANING WASTE RECEPTACLE

(71) Applicant: Fouad Sader, Torrance, CA (US)

(72) Inventor: Fouad Sader, Torrance, CA (US)

(21) Appl. No.: 13/742,331

(22) Filed: Jan. 15, 2013

Related U.S. Application Data
(60) Provisional application No. 61/586,895, filed on Jan. 16, 2012.

(51) Int. Cl. B08B 9/08

(52) U.S. Cl. CPC B08B 9/08
USPC 206/216

(57) ABSTRACT

A self-cleaning waste receptacle that includes a waste receptacle with an interior and a receptacle cleaning device. The receptacle cleaning device includes a metal casing, a top cover, a chemical cylinder cartridge and a plurality of spray nozzles. The metal casing protects the receptacle cleaning device and includes a plurality of apertures, a top and an interior. The chemical cylinder cartridge is placed in the interior of the waste receptacle and encases one or more refillable chemical cylinders. The one or more refillable chemical cylinders contain one or more pesticides or one or more disinfectants that inhibit pest and insect habitation and terminate pest infestation within the self-cleaning waste receptacle. The receptacle cleaning device also includes a cartridge grasping area, a keyed lock aperture, a user interface and a timer.

This application claims priority to U.S. Provisional Application 61/586,895 filed on Jan. 16, 2012, the entire disclosure of which is incorporated by reference.

### BACKGROUND OF THE INVENTION

1. Field of the Invention

The present invention is a waste receptacle. More specifically, the present invention is a self-cleaning waste receptacle.

2. Description of the Related Art

Many waste receptacles present users with both an environmental problem and a sanitary problem that often occurs with an open-lid waste receptacle and a closed-lid waste receptacle. A big problem with these types of waste receptacles is that they accumulate a large amount of household and other type of waste and turn into fermentation vessels of pathogenic bacteria. This often causes bad odors, pest infestations and other environmental problems.

The present invention solves these problems by automatically spraying a mist of one or more chemicals that disinfects a receptacle to significantly lower pathogenic bacterial content and neutralizes odors and releases one or more pesticides or one or more disinfectants that inhibits pest and insect habitation and terminates pest infestation.

### BRIEF SUMMARY OF THE INVENTION

The present invention is a waste receptacle. More specifically, the present invention is a self-cleaning waste receptacle.

The present invention can be utilized in a closed-lid waste receptacle and an open-lid waste receptacle. It can incorporate one or more different types of chemicals to achieve different results pertaining to one or more required sanitation and decontamination levels. The chemicals utilized can be adjusted to exterminate certain types of insects whose occurrence may be more prominent in certain cities. The present invention also utilizes a timer to increase or decrease sanitation and decontamination intensity.

The present invention is a self-cleaning waste receptacle that includes a waste receptacle with an interior and a receptacle cleaning device. The waste receptacle is typically a municipal waste receptacle but can be any suitable type of waste receptacle. The waste receptacle can be an open waste receptacle but the waste receptacle can also be a closed waste receptacle with a top cover. The receptacle cleaning device includes a metal casing, a top cover, a chemical cylinder cartridge and a plurality of spray nozzles. The receptacle cleaning device is typically disposed within the interior of the waste receptacle but can be disposed on an exterior of the receptacle cleaning device. The metal casing protects the receptacle cleaning device and includes a plurality of apertures, a top and an interior. The metal casing can also be made of plastic or any other suitable material. The top cover is hinged to the top of the metal casing to allow access to the interior of the metal casing. The chemical cylinder cartridge is placed in the interior of the waste receptacle and encases one or more refillable chemical cylinders. The one or more refillable chemical cylinders contain one or more pesticides or one or more disinfectants that inhibit pest and insect habitation and terminate pest infestation within the self-cleaning waste receptacle. The spray nozzles are disposed on the one or more refillable chemical cylinders dispersing the one or more pesticides or one or more disinfectants through the apertures of the metal casing into the interior of the waste receptacle. The receptacle cleaning device also includes a cartridge grasping area, a keyed lock aperture, a user interface and a timer.

It is an object of the present invention to provide a self-cleaning waste receptacle that is self-cleaning.

It is an object of the present invention to provide a self-cleaning waste receptacle that automatically sprays one or more chemicals in a mist form that disinfects the receptacle to significantly lower the pathogenic bacterial content and neutralizes odors within the self-cleaning waste receptacle.

It is an object of the present invention to provide a self-cleaning waste receptacle that releases a pesticide that inhibits pest and insect habitation and terminates any pest infestation within the self-cleaning waste receptacle.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an environmental perspective view of a self-cleaning waste receptacle, in accordance with one embodiment of the present invention.

FIG. 2 illustrates a cross-sectional view along line 1-1 of a receptacle cleaning device, in accordance with one embodiment of the present invention.

FIG. 3 illustrates a top perspective view of a receptacle cleaning device, in accordance with one embodiment of the present invention.

FIG. 4 illustrates an exploded perspective view of a chemical cylinder cartridge, in accordance with one embodiment of the present invention.

FIG. 5 illustrates an exploded perspective view of a chemical cylinder cartridge, in accordance with one embodiment of the present invention.

### DETAILED DESCRIPTION OF ILLUSTRATIVE EMBODIMENTS

Various aspects of the illustrative embodiments will be described utilizing terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

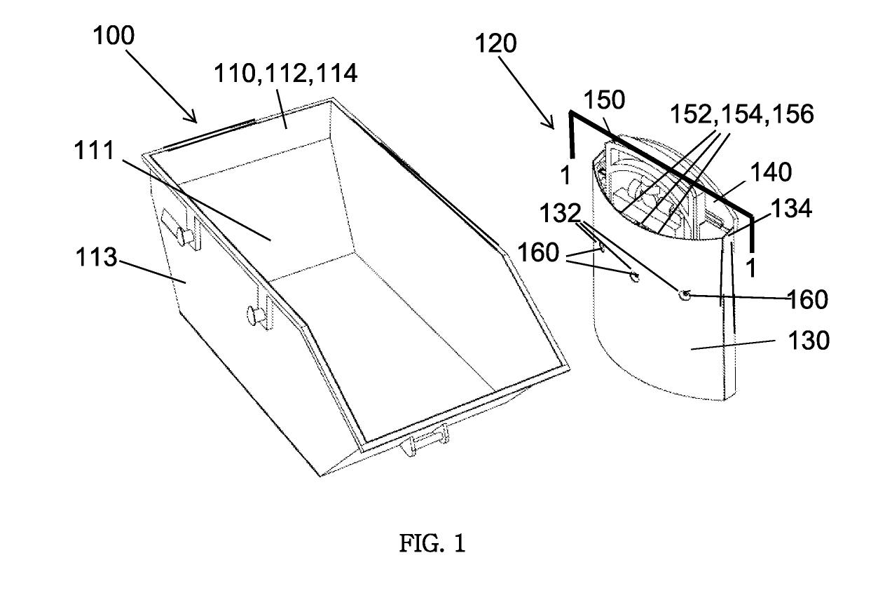

FIG. 1 illustrates an environmental perspective view of a self-cleaning waste receptacle 100, in accordance with one embodiment of the present invention. The self-cleaning waste receptacle 100 includes a waste receptacle 110 with an interior 111 and a receptacle cleaning device 120. The waste receptacle 110 is typically a municipal waste receptacle 112 but can be any suitable type of waste receptacle. The waste receptacle 110 illustrated in FIG. 1 is also an open waste receptacle 114 but the waste receptacle 110 can also be a closed waste receptacle (not shown) with a top cover (not shown). The receptacle cleaning device 120 includes a metal casing 130, a top cover 140, a chemical cylinder cartridge 150 and a plurality of spray nozzles 160. The receptacle cleaning device 120 is typically disposed within the interior 111 of the waste receptacle 110 but can be disposed on an exterior 113 of the receptacle cleaning device 120. The metal casing 130 protects the receptacle cleaning device 120 and includes a plurality of apertures 132, a top 134 and an interior 136. The metal casing 130 can also be made of plastic or any other suitable material. The top cover 140 is hinged to the top 134 of the metal casing 130 to allow access to the interior 136 of the metal casing 130. The chemical cylinder cartridge 150 is placed in the interior 111 of the waste receptacle 110 and encases one or more refillable chemical cylinders 152. The one or more refillable chemical cylinders 152 contain one or more pesticides 154 or one or more disinfectants 156 that inhibit pest and insect habitation and terminate pest infestation within the self-cleaning waste receptacle 100. The spray nozzles 160 are disposed on the one or more refillable chemical cylinders 152 dispersing the one or more pesticides 154 or one or more disinfectants 156 through the apertures 132 of the metal casing 130 into the interior 111 of the waste receptacle 110.

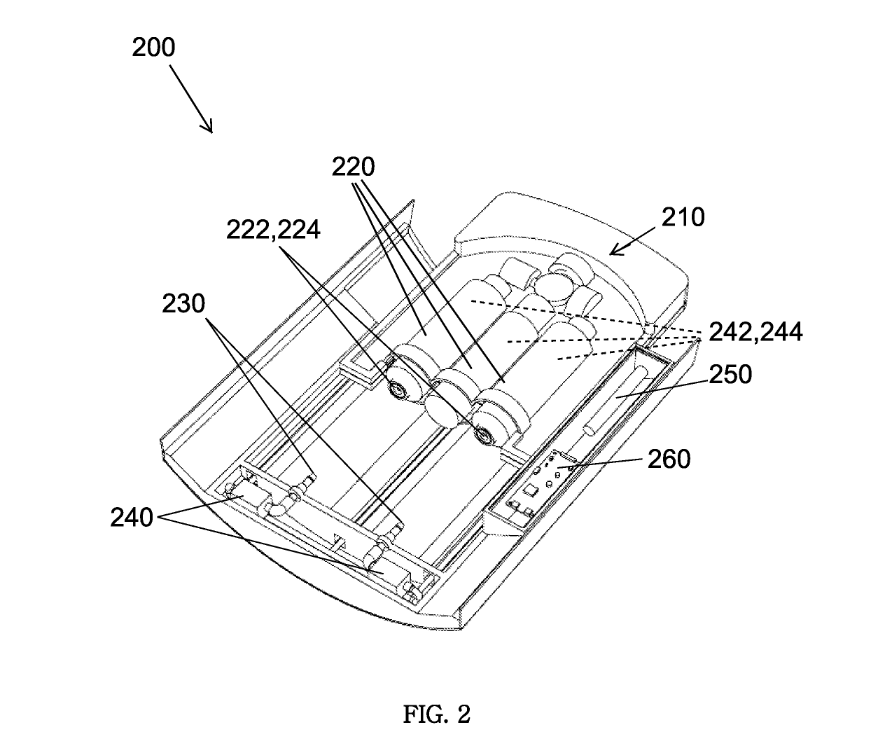

FIG. 2 illustrates a cross-sectional view along line 1-1 of a receptacle cleaning device 200, in accordance with one embodiment of the present invention. The receptacle cleaning device 200 includes a chemical cylinder cartridge 210, one or more refillable chemical cylinders 220, a plurality of connection points 230, a plurality of electronically controlled valves 240, a built-in battery 250 and a programmable circuit board 260. The chemical cylinder cartridge 210 illustrated in FIG. 2 is partially installed in the receptacle cleaning device 200. The one or more refillable chemical cylinders 220 each include a bottom 222 with an aperture connection point 224. The one or more nozzle connection points 230 are aligned to receive one or more aperture connection points 224 on the bottom 222 of the one or more refillable chemical cylinders 220. The electronically controlled valves 240 control the one or more nozzle connection points 230 to disperse one or more pesticides 242 or one or more disinfectants 244 that inhibit pest and insect habitation and terminate pest infestation within the self-cleaning waste receptacle 100. The built-in battery 250 provides electrical power to the receptacle cleaning device 200. The programmable circuit board 260 controls the built-in battery 250 and the one or more electronically controlled valves 240 of the receptacle cleaning device 200 to disperse the one or more pesticides 242 or one or more disinfectants 244. The programmable circuit board 260 controls one or more time release functions and provides one or more monitoring functions for air tank capacity, chemical capacity, and monitoring a maintenance schedule and other possible automation features.

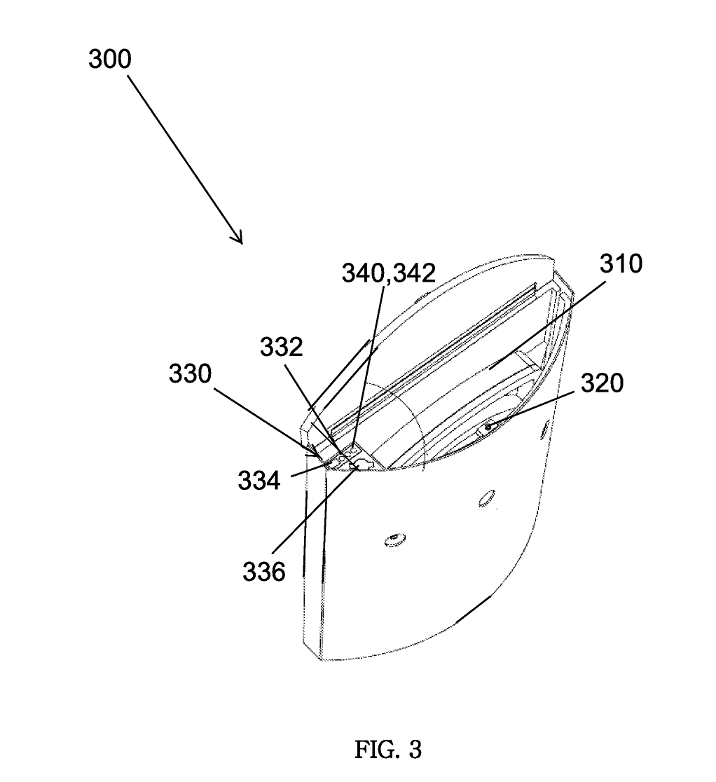

FIG. 3 illustrates a top perspective view of a receptacle cleaning device 300, in accordance with one embodiment of the present invention. The receptacle cleaning device 300 includes a cartridge grasping area 310, a keyed lock aperture 320, a user interface 330 and a timer 340. The cartridge grasping area 310 protrudes upward from a top portion 312 of a chemical cylinder cartridge 314 to accommodate a user grasping the cartridge grasping area 310. The user interface 330 includes a touchpad 332, a display 334 and a built-in battery 336. The touchpad 332 allows a user to enter data into the user interface 330. The display 334 is a digital display 336 that displays digital data. The built-in battery 336 provides electrical power to the receptacle cleaning device 300. The timer 340 is an electronic timer 342 to increase or decrease sanitation and decontamination intensity.

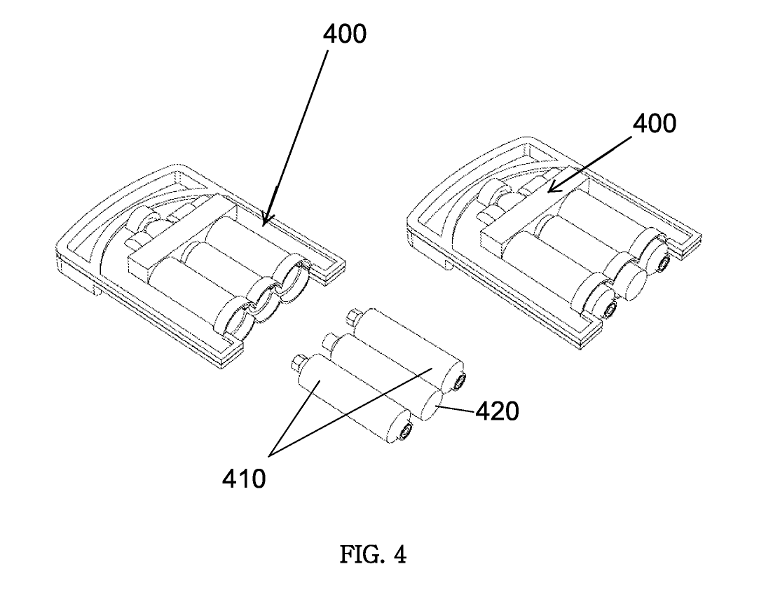

FIG. 4 illustrates an exploded perspective view of a chemical cylinder cartridge 400, in accordance with one embodiment of the present invention. The chemical cylinder cartridge 400 includes one or more refillable chemical cylinders 410 and a refillable pneumatic cylinder 420. The chemical cylinder cartridge 400 illustrates the one or more refillable chemical cylinders 410 and the refillable pneumatic cylinder 420 outside of the chemical cylinder cartridge 400 and the one or more refillable chemical cylinders 410 and the refillable pneumatic cylinder 420 inserted in the chemical cylinder cartridge 400. FIG. 4 illustrates a pair of chemical cylinders 410.

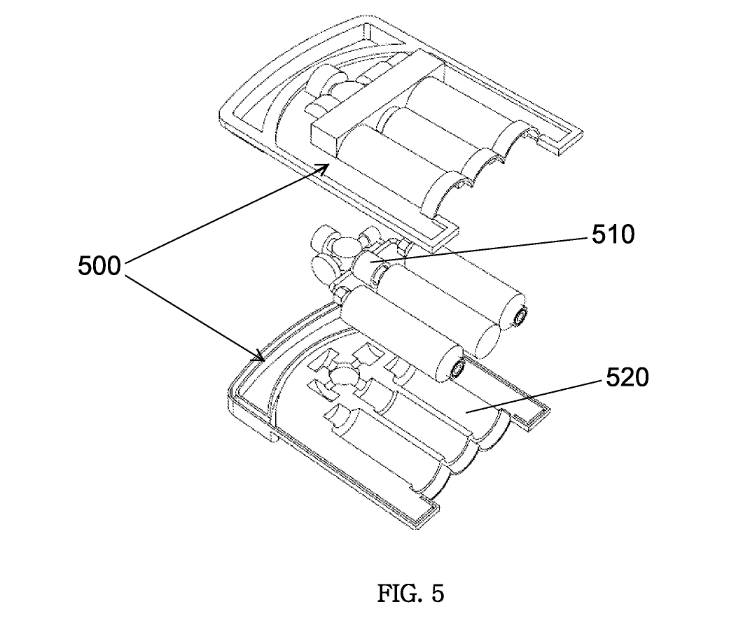

FIG. 5 illustrates an exploded perspective view of a chemical cylinder cartridge 500, in accordance with one embodiment of the present invention. The chemical cylinder cartridge 500 includes an air pressure regulator 510 and one or more refillable chemical cylinders 520 and a refillable pneumatic cylinder 530. The chemical cylinder cartridge 500 has a first half 502 and a second half 504, the first half 502 and the second half 504 contain the one or more refillable chemical cylinders 520 and the refillable pneumatic cylinder 530. The air pressure regulator 510 includes a plurality of pipes 512 that are in communication with the air pressure regulator 510 and the one or more refillable chemical cylinders 520 and the refillable pneumatic cylinder 530. The air pressure regulator 510 controls the compressed air pressure in the refillable pneumatic cylinder 530. The one or more refillable chemical cylinders 520 and the refillable pneumatic cylinder 530 contain one or more pesticides 532 or one or more disinfectants 534 that inhibit pest and insect habitation and terminate pest infestation. FIG. 5 illustrates a pair of refillable chemical cylinders 520. The refillable pneumatic cylinder 530 contains compressed air to provide pneumatic power to the chemical cylinder cartridge 500 and disperse one or more pesticides 522 or one or more disinfectants 524 in the pair of refillable chemical cylinders 520.

The self-cleaning waste receptacle can be utilized as a closed-lid waste receptacle and an open-lid waste receptacle. The receptacle cleaning device can incorporate one or more different types of chemicals to achieve different results pertaining to one or more required sanitation and decontamination levels. The chemicals utilized can be adjusted to exterminate certain types of insects whose occurrence may be more prominent in certain cities. The present invention also utilizes a timer to increase or decrease sanitation and decontamination intensity.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A self-cleaning waste receptacle, comprising:
a waste receptacle having an interior; and
a receptacle cleaning device having a metal casing, a top cover, a chemical cylinder cartridge and a plurality of spray nozzles, the receptacle cleaning device is disposed within the interior of the waste receptacle, the metal casing protects the receptacle cleaning device, the metal casing having a plurality of apertures, a top and an interior, the chemical cylinder cartridge is placed in the interior of the metal casing and encases one or more refillable chemical cylinders, the one or more refillable chemical cylinders each include a bottom with an aperture connection point and the one or more refillable chemical cylinders contain a selected one of one or more pesticides and one or more disinfectants that inhibit pest and insect habitation and terminate pest infestation within the self-cleaning waste receptacle.

2. The self-cleaning waste receptacle according to claim 1, wherein the waste receptacle a municipal waste receptacle.

3. The self-cleaning waste receptacle according to claim 1, wherein the waste receptacle is an open waste receptacle.

4. The self-cleaning waste receptacle according to claim 1, wherein the spray nozzles are disposed on the one or more refillable chemical cylinders dispersing the selected one of one or more pesticides and one or more disinfectants through the apertures of the metal casing into the interior of the waste receptacle.

5. The self-cleaning waste receptacle according to claim 1, further comprising a plurality of nozzle connection points, a plurality of electronically controlled valves, a built-in battery and a programmable circuit board.

6. The self-cleaning waste receptacle according to claim 5, wherein the one or more nozzle connection points are aligned to receive one or more aperture connection points on the bottom of the one or more refillable chemical cylinders.

7. The self-cleaning waste receptacle according to claim 5, wherein the electronically controlled valves control the one or more nozzle connection points to disperse the selected one of one or more pesticides and one or more disinfectants.

8. The self-cleaning waste receptacle according to claim 5, wherein the programmable circuit board controls the built-in battery and the one or more electronically controlled valves of the receptacle cleaning device to disperse the selected one of the one or more pesticides and one or more disinfectants.

9. The self-cleaning waste receptacle according to claim 5, wherein the programmable circuit board controls one or more time release functions and provides one or more monitoring functions to monitor air tank capacity, chemical capacity and a maintenance schedule.

10. The self-cleaning waste receptacle according to claim 1, further comprising a cartridge grasping area, a keyed lock aperture, a user interface and a timer.

11. A receptacle cleaning device disposed within an interior of a waste receptacle, comprising:
a metal casing having a plurality of apertures, a top and an interior, the metal casing protects the receptacle cleaning device;
a top cover hinged to the top of the metal casing;
a chemical cylinder cartridge, the chemical cylinder cartridge placed in the interior of the metal casing and encases one or more refillable chemical cylinders, the one or more refillable chemical cylinders each include a bottom with an aperture connection point and the one or more refillable chemical cylinders contain a selected one of one or more pesticides and one or more disinfectants that inhibit pest and insect habitation and terminate pest infestation within the self-cleaning waste receptacle; and
a plurality of spray nozzles, the spray nozzles are disposed on the one or more refillable chemical cylinders.

12. The self-cleaning waste receptacle according to claim 11, wherein the waste receptacle is a municipal waste receptacle.

13. The self-cleaning waste receptacle according to claim 11, wherein the waste receptacle is an open waste receptacle.

14. The self-cleaning waste receptacle according to claim 11, wherein the spray nozzles are dispersing the selected one of one or more pesticides and one or more disinfectants through the apertures of the metal casing into the interior of the waste receptacle.

15. The self-cleaning waste receptacle according to claim 11, further comprising a plurality of nozzle connection points, a plurality of electronically controlled valves, a built-in battery and a programmable circuit board.

16. The self-cleaning waste receptacle according to claim 15, wherein the one or more nozzle connection points are aligned to receive one or more aperture connection points on the bottom of the one or more refillable chemical cylinders.

17. The self-cleaning waste receptacle according to claim 15, wherein the electronically controlled valves control the one or more nozzle connection points to disperse the selected one of one or more pesticides and one or more disinfectants.

18. The self-cleaning waste receptacle according to claim 15, wherein the programmable circuit board controls the built-in battery and the one or more electronically controlled valves of the receptacle cleaning device to disperse the selected one of the one or more pesticides and one or more disinfectants.

19. The self-cleaning waste receptacle according to claim 15, wherein the programmable circuit board controls one or more time release functions and provides one or more monitoring functions to monitor air tank capacity, chemical capacity and a maintenance schedule.

20. The self-cleaning waste receptacle according to claim 11, further comprising a cartridge grasping area, a keyed lock aperture, a user interface and a timer.
